(19) United States
(12) Patent Application Publication
(10) Pub. No.: US 2005/0150985 A1
(43) Pub. Date: Jul. 14, 2005

(54) Grinding method by means of pendulum ring roller mills and closed-circuit pendulum ring roller mills implementing such a method

(76) Inventor: Edmond Soudron, Liege (BE)

Correspondence Address: SUGHRUE MION, PLLC, 2100 PENNSYLVANIA AVENUE, N.W., SUITE 800, WASHINGTON, DC, 20037, US

(21) Appl. No.: 11/033,261

(22) Filed: Jan. 12, 2005

(30) Foreign Application Priority Data
Jan. 13, 2004 (BE) 2004/0020

(51) Int. Cl. B02C 23/24

(52) U.S. Cl. 241/57; 241/80

(57) ABSTRACT

The invention concerns a method of grinding combustible products by means of closed-circuit pendulum ring roller mills, comprising a top ring, serving as a support for the running track of the mill, and a base structure provided with a grinding sole plate, preventing the deposition of combustible particles in the air inlet circuit of the mill. The invention also concerns closed-circuit pendulum ring roller mills for implementing such a method.

The present invention concerns improvement to the characteristics of use of pendulum ring roller mills, more particularly closed-circuit pendulum ring roller mills, and especially such mills used for direct heating.

In a ventilated mill, the air serving for the transportation of the product is sucked in by the main fan and passes successively through the mill, the selector, the cyclone and/or the filter, and the fan, and returns to the mill (closed circuit) or leaves to atmosphere (open circuit).

The mill therefore forms part of an air circuit which may be closed or open.

Closed Circuit

In a closed circuit the cyclone and/or filtered air leaving the fan returns once again into the mill, with the exception of that which is necessary to discharge, that is to say the excess air and the steam extracted during any drying.

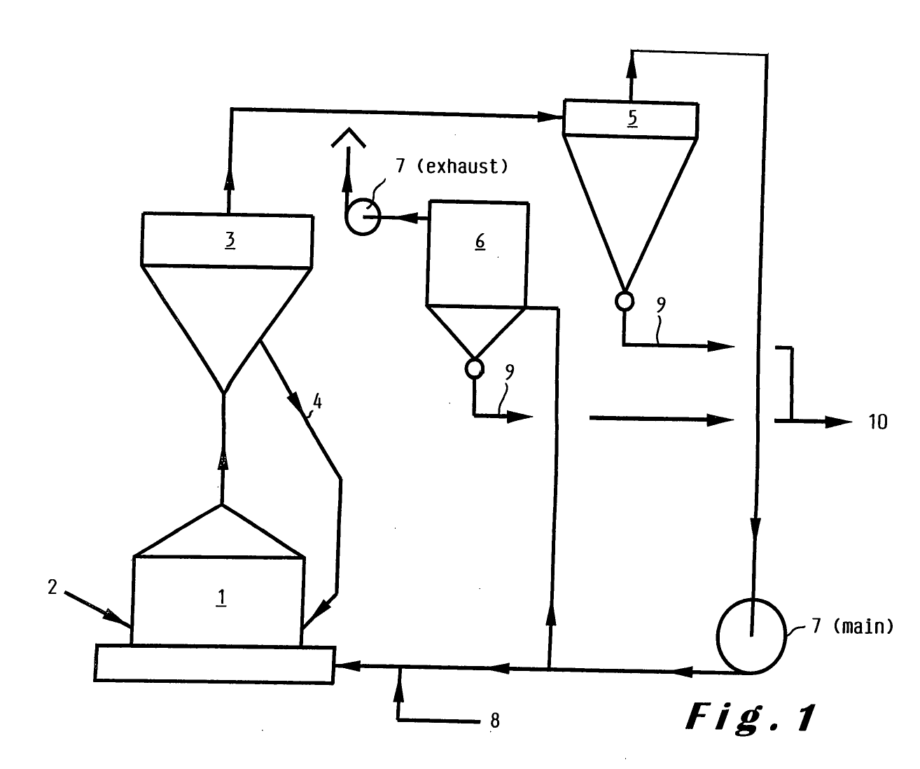

In a first case, after the cyclone and fan, only the excess air and steam are sucked through a filter by a second fan and discharged to atmosphere. See FIG. 1 (conventional closed circuit, the filter deals only with the exhaust air). Indirect heating with PF silo.

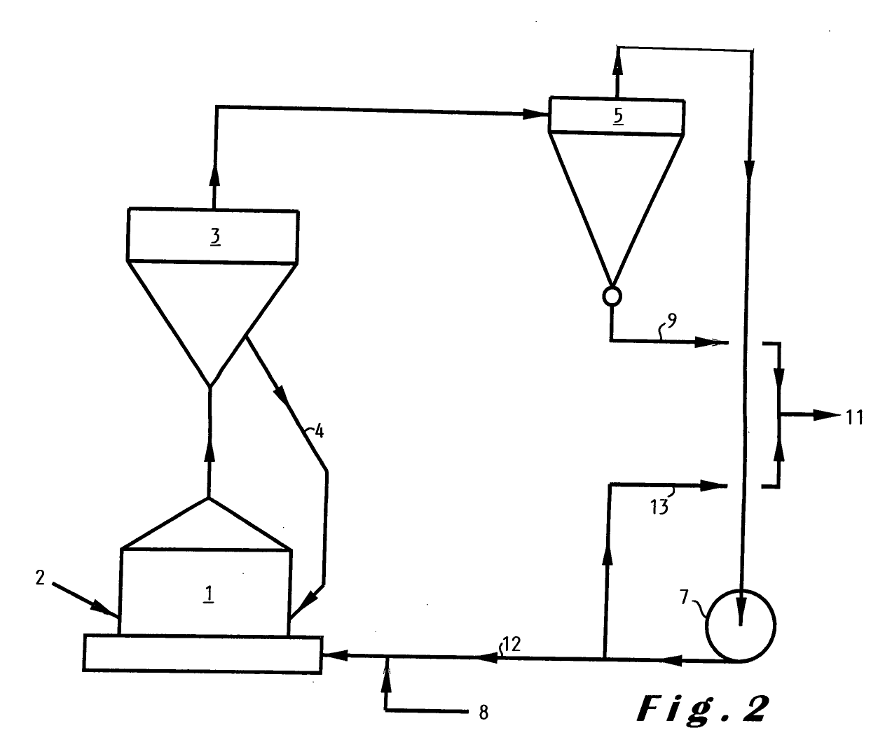

In a second case they are sent to the burner as combustion air, and therefore without any filter. See FIG. 2 (direct heating without intermediate storage of pulverised fuel).

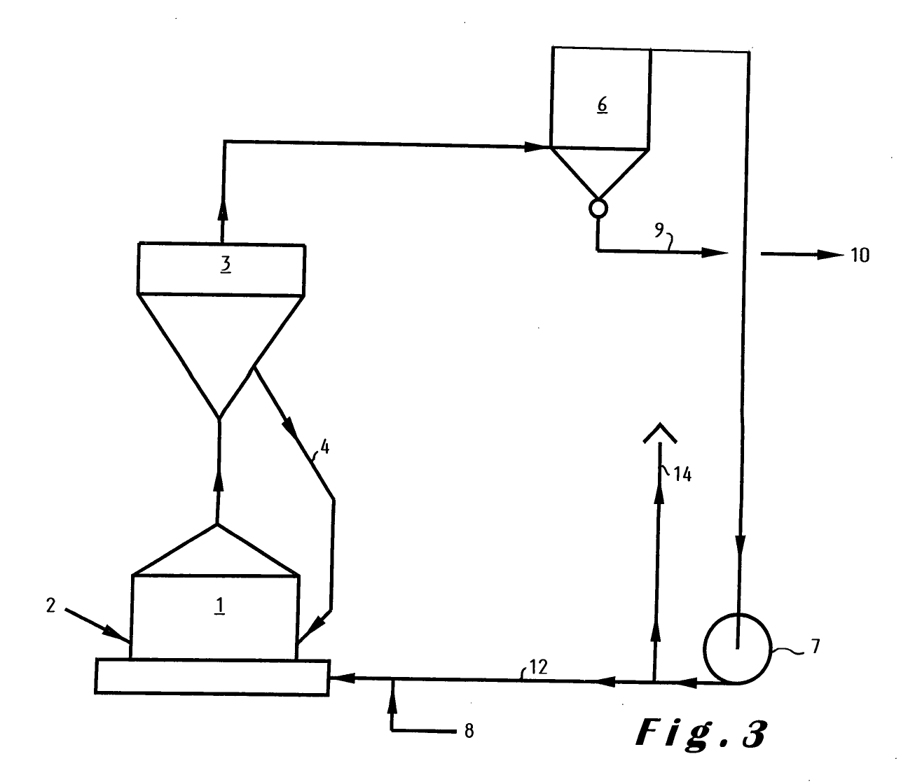

In a third case, all the air flow, cycloned or not, is sent to the filter, before being sucked by the fan. See FIG. 3 (closed circuit with filter in the circuit), processing all the flow).

Which prevents the recirculation of undesirable fine particles.

At the discharge from the fan, some of the gaseous flow once again returns to the mill and the rest is a discharged to atmosphere.

However, this arrangement is more expensive since the filter must process a large air flow.

In the three cases, the air which is not in excess is therefore recirculated, which offers two advantages: a saving in heat and the possibility of maintaining the low oxygen content in the case of a grinding/drying of flammable materials, in so far as the hot air comes from combustion gases.

Open Circuit

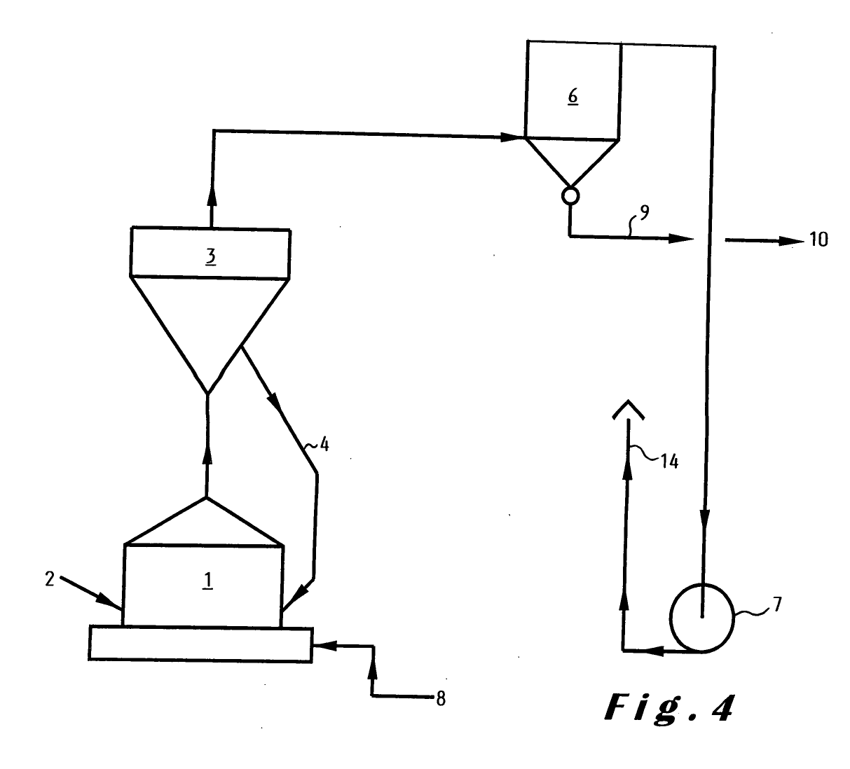

In an open circuit all the air is filtered as in the third case already mentioned but there is no longer any recirculation and all the air is discharged to atmosphere. See FIG. 4 (open circuit with filter in the circuit, processing all the flow. Indirect heating with PF silo). This arrangement combines three drawbacks: large expensive filter, waste of heat and expensive inerting.

All the types of mill can function in accordance with these systems.

However, vertical pendulum ring roller mills (fixed track) are best suited to drying, since they profit from a better heat exchange by virtue of the fluidised bed of the wet material being ground.

The present invention concerns mills working in closed circuit, according to the second case, without filter (see FIG. 2).

The objective of the invention is an adaptation of the base of the mill and of the hot-gas circuit, which avoids dead areas where deposits subject to possible spontaneous combustion accumulate.

To achieve this objective the invention provides a closed-circuit mill with pendulum rollers, for grinding combustible products, comprising a top ring serving as a support for the running track and a base structure provided with a sole plate, and means for preventing the deposition of combustible particles in the inlet circuit of the mill, the said means for preventing the deposition of combustible particles in the air inlet circuit of the mill comprising a conical or cylindrical external wall, pierced with openings, providing the connection between the said top ring and the said sole plate.

In a preferred embodiment of the invention the hot air is brought into the grinding chamber through conduits passing through the said openings whilst preventing contact of the hot air with the said base structure.

According to one particularity of the invention the hot air feed preferably comes from an air collector remote from the mill.

According to another preferred particularity of the invention, the said means for preventing the deposition of combustible particles in the air inlet circuit of the mill can also comprise hot air injectors directed towards the bottom of the entire internal perimeter, in the mass of the fluidised bed.

The mill according to the invention preferably also comprises lifting blades providing mechanical fluidisation of the mass of the bed.

In a particularly preferred embodiment of the invention, the said means for preventing the deposition of combustible particles in the air inlet circuit of the mill implement a hot air feed circuit leading to the downward movement of the air and particles and to the discharge of the fine particles in the grinding chamber.

The invention also concerns a method of grinding combustible products by means of a mill with a top ring and a base structure for a grinding sole plate, which method prevents the deposition of combustible particles in the mill and the direct contact of hot air introduced into the mill with the base structure of the mill.

In a preferred embodiment of the invention the hot air introduced into the mill comes from an air collector.

According to one particularity of the invention, the hot air is preferably injected towards the bottom of the entire internal perimeter of the mill, in the mass of a bed fluidised mechanically by lifting blades.

According to another particularity of the invention, the hot air is preferably injected at high speed towards the bottom of the fluidised mass of a product to be dried and ground.

In a particularly preferred embodiment of the invention, the hot air brought into the mill makes a circuit in such a way that the air and fine particles in suspension move downwards, thus ensuring the discharge of the fine particles into the grinding chamber.

Hereinafter the invention is explained in more detail, making reference to the accompanying drawings, in which

FIGS. 1-4 depict schematically known grinding installations according to the prior art;

FIG. 5 depicts schematically an embodiment of a grinding installation according to the invention;

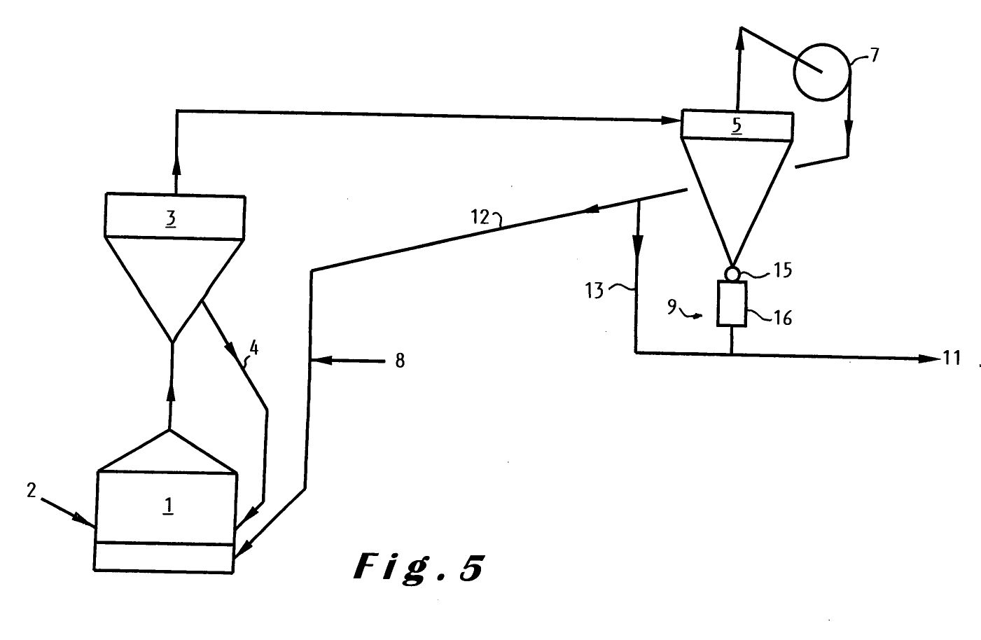

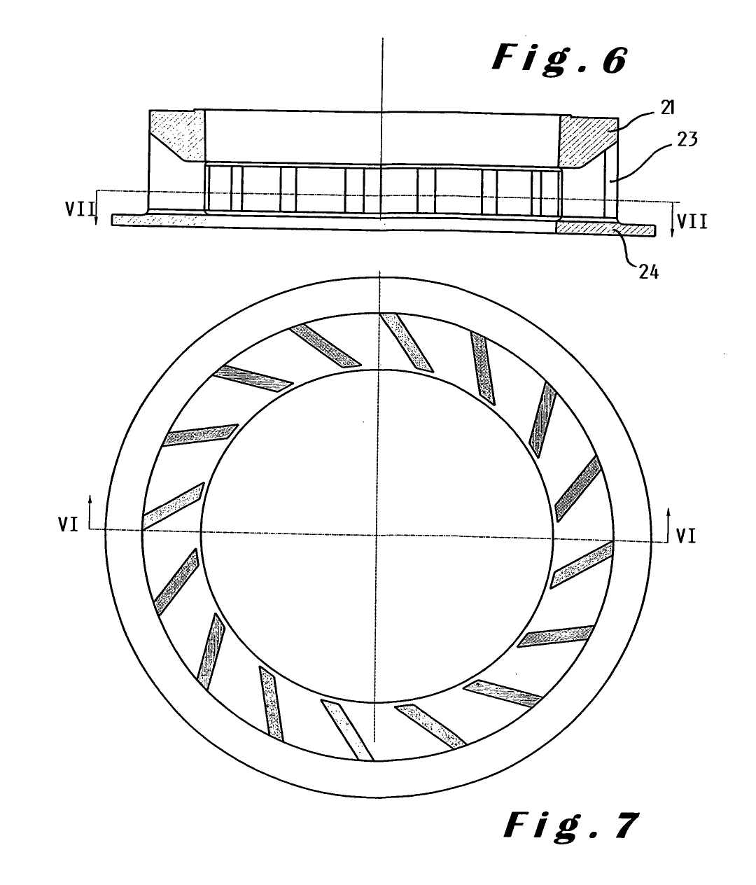

FIGS. 6 and 7 depict schematically the base of a traditional pendulum ring roller mill (shown in side view and in section seen from above);

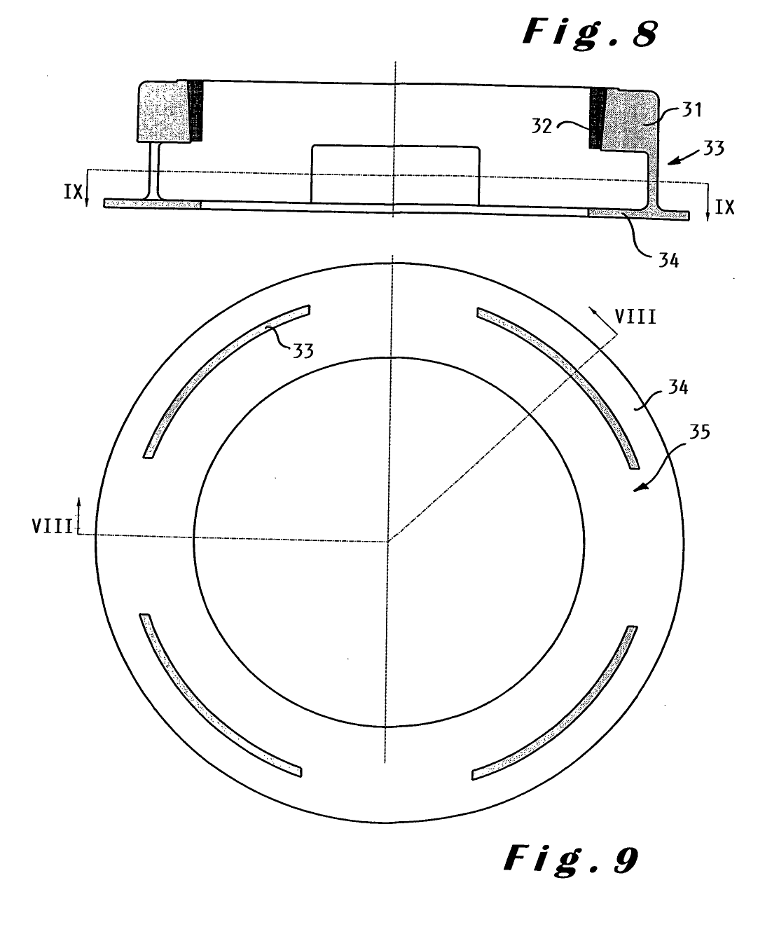

FIGS. 8 and 9 depict schematically an embodiment of the base of a pendulum ring roller mill according to the invention (shown in cross section in side view and in cross section seen from above);

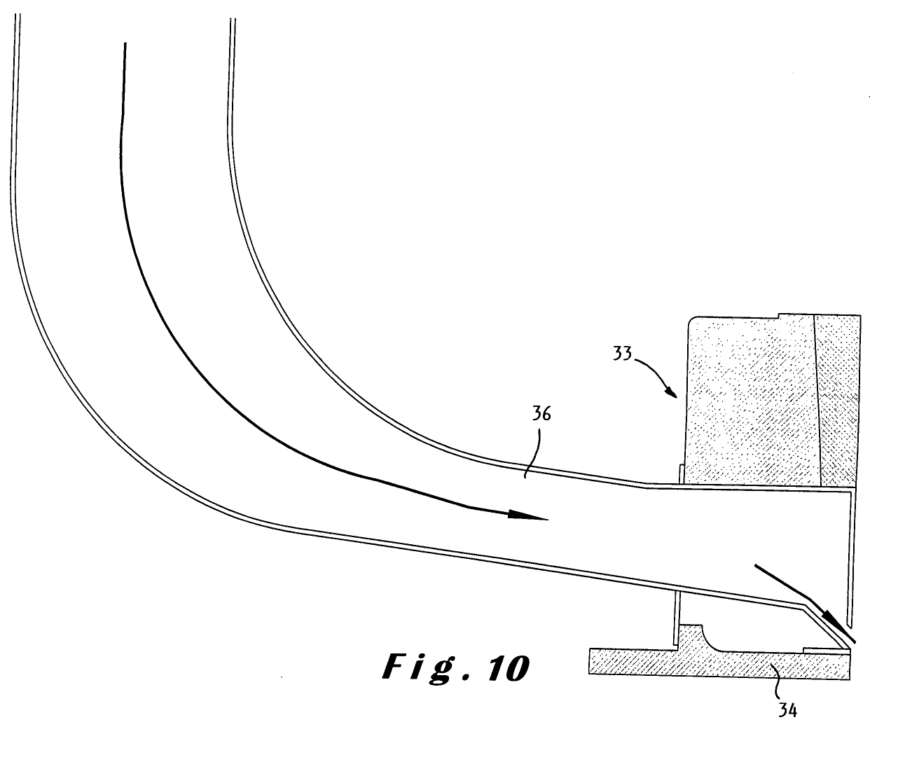

FIG. 10 depicts schematically an embodiment of an air feed into the mill according to the invention.

In these figures corresponding elements are designated by the same reference number, namely
a pendulum ring roller mill (1),
a feed (2)
a selector (3)
a reject return (4)
a cyclone (5)
one or more filters (6)
one or more fans (7)
a hot air inlet (8)
one or more product discharges (9)
a discharge to a pulverised fuel silo (10)
a burner (11)
a partial recirculation of recycled air (12)
a partial discharge of recycled air (13)
a partial discharge of filtered air (exhaust) (14)
a discharge airlock (15)
a flow meter for pulverised fuel (16)

The installation in FIG. 5 according to the invention (involving direct heating without intermediate storage of fuel) has a flow sheet identical to that of the installation in FIG. 2, but:
1) the volute surrounding the base of the mill has been omitted and
2) the fan is placed close to the cyclone instead of the mill.

The method also having the advantage of reducing thermal stresses, and also and principally reducing the cost of manufacture of the mill, it is also advantageous to apply the novel design in the treatment of inert materials.

According to the prior art, there exist two families of vertical mills:
with a table-track in rotation in which the hot gases reach the wet product only at the discharge from the table, where it has been partially ground.
with a fixed track and rotating pendulums, in which the hot gases reach the wet product as soon as it enters the mill. These fixed-track pendulum ring roller mills are best suited to drying since they profit from a better heat exchange by virtue of the fluidised bed of the wet material in the course of grinding.

It is to the mills in the second family that the invention can apply. Those in the first family have, with regard to drying, an incorrigible defect since the hot air is not instantaneously in contact with the cold and/or wet product.

Description of the Traditional Base of a Pendulum Ring Roller Mill (FIGS. 6 and 7)

The fixed track consists of a ring (21) with a large cross section capable of withstanding the running of the rollers.

This ring is armoured by means of a wearing part (22) referred to as the running track (ring) for the pendulum rollers.

This solid ring is supported by a multitude of columns (23) which bear on a sole plate (24) in the form of a disc, held by anchoring bolts, on the foundation.

The columns serve as vanes allowing the passage of the air used for the transportation of the ground material. This is air at high temperature if the product is to be dried.

The assembly consisting of ring, columns and sole plate is referred to as the base.

The base is surrounded by a chamber, in the form of a volute, which distributes the air, possibly at a high temperature, all around through the vanes.

A large surface of the base serves as an internal wall for the volute feeding hot air at high speed and with a high heat transmission.

Description of the Novel Base According to the Invention (FIGS. 8, 9 and 10)

The vanes, providing the connection between the top ring (31), supporting the running track (32), and the sole plate (34), are replaced by a cone or an external cylinder (33).

The cone or cylinder (33) has openings (35) in it through which conduits (36) enter for feeding air, possibly at high temperature in the case of drying simultaneous with the grinding.

There is therefore no longer any volute (see description of FIG. 5, page 5, point 1). Direct contact of the base with the high-temperature gas is thus avoided, which reduces the thermal stresses and external radiation whilst improving the thermal efficiency.

The air circuit after the cyclone comprises no rising part where there would be a risk of material being deposited. It is a question of material in recirculation, in the case of a closed grinding circuit with a filter only on the exhaust.

The hot air is then channelled to the entire internal perimeter of the base of the mill, where it is injected downwards into the mass of the fluidised bed mechanically by the lifting blades.

By providing better injection (penetration) of the high-temperature gases at high speed towards the bottom of the fluidised mass of the product to be dried and ground, the efficacy of the heat exchange is improved.

This better efficacy of the heat exchange reduces:
the temperature of the gases in the grinding chamber,
the external radiation of the walls of the latter,
the heating of the close-by appliances such as gearbox, motor, etc.

But most importantly:

The invention makes it possible to use pendulum ring roller mills for direct heating, that is to say without storage! (expensive and dangerous) of ground fuel.

(It should be noted that mills with rotating track and fixed pendulums already permit direct heating, by virtue of their variable capacity, but see defects above).

After selection, the ground fuel is separated from the transport air via a cyclone equipped at the discharge with an appliance for measuring the actual throughput of fuel. See FIG. 5.

This measurement of the actual throughput of fuel informs the staff and makes it possible to continuously control and adapt the power of the flame, by modifying the throughput of fuel successively supplying the mill and burner.

The mill must have a variable capacity by variation of speed and/or by variation of pressure of the rollers on the track, in accordance with the technique described in the patent application PCT/BE02/00012.

After the discharge from the fan, placed after the cyclone, the still slightly dusty air is divided into two flows.

First of all the flow of air necessary for combustion is provided. Via a fan providing the necessary pressure and by virtue of a venturi the atomised fuel, whose flow has been measured, is remixed with the combustion air. This mixture is then sent, through the burner, into the combustion chamber.

Before the invention, the excess air had to be discharged to the combustion chamber in order to prevent any deposit liable one day to spontaneously combust.

Now the air leaving the cyclone and not used for combustion is recirculated to the mill with all the advantages mentioned. Gases at high temperature are added to it, in order to ensure the necessary addition of heat.

The essential aspects of the invention are as follows:

The method prevents any deposition of fuel in the volute of the pendulum ring roller mill working in a closed circuit. This method also affords technical advantages cited below and cost advantages. It is based on the following adaptations.

Replacement of the vanes, providing the connection between the top ring (supporting the running track) and the sole plate, by means of a conical or cylindrical external wall, with openings in it. See FIG. 8.

The openings allowing passage of the conduits for feeding hot air independent of the base, thus preventing direct contact of the hot air with the structure of the base and its unnecessary heating and risk of burning. See FIGS. 8-10.

The hot air supply coming from an air collector, replacing the volute at floor level. This prevents any deposit in this collector. See FIG. 10.

The hot air injectors to the bottom of the entire internal perimeter, in the mass of the bed fluidised mechanically by the lifting blades. See FIG. 10.

By providing better injection (penetration) of the high-temperature gases at high speed towards the bottom of the fluidised bed of the product to be dried and ground, the efficiency of the heat exchange is improved.

The hot air feed circuit produced so that the air and the fine particles in suspension move downwards, thus providing the discharge of the fine particles in the grinding chamber and preventing any dangerous deposit. See FIG. 10.

1. Closed-circuit pendulum ring roller mill, for grinding combustible products, comprising a top ring serving as a support for the running track and a base structure provided with a sole plate, and means for preventing the deposition of combustible particles in the air inlet circuit of the mill, characterised in that the said means for preventing the deposition of combustible particles in the air inlet circuit of the mill comprise a conical or cylindrical external wall, with openings in it, providing the connection between the said top ring and the said sole plate.

2. Mill according to claim 1, characterised in that hot air is brought into the grinding chamber through conduits passing through the said openings and preventing contact of the hot air with the said base structure.

3. Mill according to claim 2, characterised in that the hot air supply comes from an air collector remote from the mill.

4. Mill according to claim 1, characterised in that the said means for preventing the deposition of combustible particles in the air inlet circuit of the mill comprise hot air injectors directed towards the bottom of the entire internal perimeter, in the mass of the fluidised bed.

5. Mill according to claim 4, characterised in that it comprises lifting blades providing mechanical fluidisation of the mass of the bed.

6. Mill according to claim 1, characterised in that the said means for preventing the deposition of combustible particles in the inlet circuit of the mill produce a hot air feed circuit leading to the movement of air and particles downwards and to the discharge of the fine particles in the grinding chamber.

7. Method of grinding combustible products by means of a mill comprising a top ring, serving as a support for the running track, and a base structure provided with a sole plate, which method prevents the deposition of combustible particles in the mill, characterised in that the method prevents direct contact of hot air introduced into the mill with the base structure of the mill.

8. Method according to claim 7, characterised in that the hot air introduced into the mill comes from an air collector.

9. Method according to claim 7, characterised in that hot air is injected towards the bottom of the entire internal perimeter of the mill, in the mass of a bed fluidised mechanically by lifting blades.

10. Method according to claim 7, characterised in that hot air is injected at high speed towards the bottom of the fluidised mass of a product to be dried and ground.

11. Method according to claim 7, characterised in that the hot air brought into the mill produces a circuit so that the air and fine particles in suspension move downwards, thus providing the discharge of the fine particles in the grinding chamber.
